(19) United States
(12) Patent Application Publication
(10) Pub. No.: US 2005/0199332 A1
(43) Pub. Date: Sep. 15, 2005

(54) Hosiery mending composition and method

(76) Inventors: Deborah Conner Scott, Pleasant Hill, CA (US); Gary A. Binas, Pearblossom, CA (US); Racquel Brown Lindsay, Stockbridge, GA (US)

Correspondence Address: Michael W. Starkweather, Suite 200, 9035 South 1300East, Sandy, UT, 84094, US

(21) Appl. No.: 11/068,646

(22) Filed: Feb. 22, 2005

Related U.S. Application Data
(60) Provisional application No. 60/547,098, filed on Feb. 24, 2004.

(51) Int. Cl. B32B 35/00

(52) U.S. Cl. 156/94

(57) ABSTRACT

A hosiery mending composition and method including methyl vinyl ether maleic acid; a resin; and a solvent. There may be a hydrocarbon-based oil, nylon, Ethyl Ester of PVM/MA Copolymer, nitrocellulose, a santolite-type resin such as Tosylamide Formaldehyde Resin, Isopropyl Alcohol, Toluene, Butyl Acetate, Mineral Oil, a fragrance agent, a coloring agent, and/or conditioning agents such as plasticizers. The hosiery mending method includes applying the hosiery mending composition to hosiery material.

### BACKGROUND OF THE INVENTION

1. Field of the Invention

The present invention relates to mending compositions and methods, specifically to hosiery mending compositions and methods. Applicant claims priority to U.S. Provisional Application Ser. No. 60/547,098 filed on Feb. 24, 2004 by Deborah Conner Scott et al.

2. Description of the Related Art

In hosiery such as pantyhose or nylon stockings are made of interwoven fine threads or fibers, the threads or fibers are joined in loops of fibers. Although there have been many attempts to make hosiery resistant to damage, the fineness of the threads or fibers makes hosiery susceptible to damage, such as tears, holes, and ladders. When a loop is snagged the thread becomes loosened or broken, allowing the fabric to unravel or run. The loose end slips through adjoining loops allowing the fabric to expand at that point to form the run or ladder. The more the hosiery is stretched, the faster the run develops and the greater the damage.

One way to prevent a run in hosiery is to apply a glue to a tear, hole, or run already present in the hosiery. This is typically achieved by applying acetone-based nail polish to the tear, hole or run. Such nail polish has not proven to be very satisfactory for the purpose. For example, nail polish is brittle and can dry to a white, hard solid that often bonds the hosiery to the leg. The white solid is particularly noticeable and unattractive with dark colored hosiery. Further, when the hosiery is removed, the hard solid often causes additional snags and runs. The hosiery also can usually not be worn again after washing.

Other glues for repairing runs and snags in hosiery have been described. For example, cyanoacrylate glue has been used with a one-shot applicator. This glue, however, also dries to a brittle solid and can stick to the skin of someone wearing the hosiery. Mixtures of nitrocellulose and certain plasticizer have also been used as a glue to repair hosiery.

Various patches and patching systems have been described to repair hosiery. Patches bind to loose threads of a run, preventing the loose threads from slipping through adjacent loops and allowing the fabric to unravel. Patches are applied to the inside and outside of the stocking. Each patch has a pressure-sensitive adhesive. The pressure-sensitive adhesive binds loose threads and prevents them from further unraveling. Patches, however, are cumbersome and do not stretch, sometimes causing further damage to the repaired stocking as well as creating new imperfections. Furthermore, patches do not efficiently capture the loose thread. Thus, the run may continue even though a patch was applied.

Glues and patches available for repairing hosiery are therefore insufficient. Glues generally have not been satisfactory because they take too long to dry, leave a sticky, unsightly glob on the stocking and are inconvenient to apply. Additionally, glues can stick to the skin and cause skin irritation. Patches are cumbersome, ineffective and often cause more damage to the stocking. From the foregoing, it is apparent that there remains a need for a safe, effective, durable method by which to repair hosiery.

What is needed is a hosiery mending composition that addresses some if not all of the above issues.

### SUMMARY OF THE INVENTION

The present invention has been developed in response to the present state of the art, and in particular, in response to the problems and needs in the art that have not yet been fully solved by currently available hosiery mending articles and methods. Accordingly, the present invention has been developed to provide a hosiery mending composition.

In one embodiment there is a hosiery mending composition. The hosiery mending composition may include methyl vinyl ether maleic acid; a resin; and a solvent. There may also be included a seed polymer characterized by an ability to initiate binding during solidification of the mending composition. The seed polymer may be nylon. There may also be an oil characterized by a phobic interaction with at least a substantial portion of the composition. The oil may be Mineral Oil.

In another embodiment the resin may be Tosylamide Formaldehyde Resin. There may also be included nylon and nitrocellulose. The resin, which may be Tosylamide Formaldehyde Resin, may be characterized by an ability to harden and enhance binding strength of methyl vinyl ether maleic acid.

In still another embodiment, the solvent may include a plurality of chemicals and the solvent may be characterized by an ability to hold methyl vinyl ether maleic acid and resin in solution and may be in an amount sufficient that the resulting composition is free flowing.

In yet another embodiment there may be about 14% to about 34% by volume of Ethyl Ester of PVM/MA Copolymer; about 10% to about 20% by volume of Nitrocellulose; about 0.5% to about 4% by weight of Nylon; about 5% to about 15% by volume of a santolite-type resin; about 1% to about 13% by volume of Isopropyl Alcohol; about 13% to about 27% by volume of Toluene; and about 14% to about 38% by volume of Butyl Acetate. There may also be about 0.5% to about 4% by volume of hydrocarbon-based oil. Further, there may also be a coloring agent.

In yet still another embodiment there is a method of repairing a tear, hole, or run in hosiery. The method may include the steps of applying to the tear, hole, or run an effective amount of a mending composition comprising: methyl vinyl ether maleic acid; a resin; and a solvent; and drying the mending composition. The mending composition may further include a hydrocarbon-based oil.

The mending composition of the method may include about 14% to about 34% by volume of Ethyl Ester of PVM/MA Copolymer; about 10% to about 20% by volume of Nitrocellulose; about 0.5% to about 4% by weight of Nylon; about 5% to about 15% by volume of a santolite-type resin; about 1% to about 13% by volume of Isopropyl Alcohol; about 13% to about 27% by volume of Toluene; and about 14% to about 38% by volume of Butyl Acetate.

In another embodiment there is a hosiery mending composition including a binder that binds hosiery material; a hardener that hardens the hosiery mending composition upon a solidification of the composition; a solvent that holds the binder and the hardener in at least a flocculated solution; and a lubricant for preventing the composition from adhering to human skin during and after solidification of the composition.

In the hosiery mending composition, the binder may include methyl vinyl ether maleic acid. In the hosiery mending composition, the lubricant may be characterized by the absence of undesired interactions with human skin. In the hosiery mending composition, the solvent may hold the binder and hardener in at least a free flowing flocculated solution. In the hosiery mending composition, the hardener may be a resin.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF SUMMARY OF THE INVENTION

The subject invention relates to a mending composition, and methods of using the mending composition, for stopping or preventing runs in hosiery. It can be applied to tears, holes, runs or the like in hosiery. The mending composition generally includes polymer, resin and solvent. In certain embodiments, the mending composition includes methyl vinyl ether maleic acid such as Ethyl Ester of PVM/MA Copolymer, Nitrocellulose, Nylon, Tosylamide Formaldehyde Resin and solvent. The solvent can be, for example, Butyl Acetate, Toluene and Isopropyl Alcohol. In additional embodiments, the mending composition can further include Mineral Oil.

In a specific embodiment, the mending composition can include about 24% by volume methyl vinyl ether maleic acid such as Ethyl Ester of PVM/MA Copolymer; about 14% by volume Nitrocellulose; about 1% by weight Nylon; about 11% by volume Tosylamide Formaldehyde Resin; about 20% by volume Toluene; about 3% by volume Isopropyl Alcohol; about 26% by volume Butyl Acetate; and about 1% by volume Mineral Oil. The mending composition is optionally free of coloring agent.

The mending composition can be disposed in any suitable container. In certain embodiments, the mending composition is disposed in a dispensing container, where the composition is in suitable form for application from the container to a tear, hole or run in hosiery.

In another aspect, the mending comprises Ethyl Ester of PVM/MA Copolymer, Nitrocellulose, Nylon, Tosylamide Formaldehyde Resin, Butyl Acetate, Toluene, Isopropyl Alcohol and Mineral Oil and is disposed in a container. The mending composition is in suitable form for application from the container in gel form to a tear, hole or run in the hosiery.

In yet another aspect, methods of repairing a tear, hole or run in hosiery are provided. The methods generally include applying to the tear, hole or run an effective amount of a mending composition comprising polymer, resin and solvent. The methods also can generally include applying to the tear, hole or run an effective amount of a mending composition comprising Ethyl Ester of PVM/MA Copolymer, Nitrocellulose, Nylon, Tosylamide Formaldehyde Resin and solvent. The solvent can be, for example, Butyl Acetate, Toluene and Isopropyl Alcohol. The mending composition can optionally include Mineral Oil.

In a specific embodiment, the method includes applying to the tear, hole or run an effective amount of a mending composition comprising about 24% by volume Ethyl Ester of PVM/MA Copolymer; about 14% by volume Nitrocellulose; about 1% by weight Nylon; about 11% by volume Tosylamide Formaldehyde Resin; about 20% by volume Toluene; about 3% by volume Isopropyl Alcohol; about 26% by volume Butyl Acetate; and about 1% by volume Mineral Oil.

The mending composition can be applied from any suitable container. For example, the mending composition can be applied from an applicator in gel form to a tear, hole or run. The mending composition typically dries to a substantially colorless form when applied to hosiery worn by a person.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

The present invention provides a mending composition for stopping runs in hosiery. It can be applied to tears, holes and runs in hosiery, and is effective to prevent further damage to the hosiery. The composition can be applied to hosiery, such as nylons, pantyhose, sheer hosiery, silk stocking, support hose, compression hose, and other types of hosiery. The hosiery typically is composed of nylon, other synthetic material or silk.

The mending composition may include polymer or binder, resin or hardener, solvent, and/or oil or lubricant. The composition typically comprises polymer such as methyl vinyl ether maleic acid (for example, Ethyl Ester of PVM/MA Copolymer), Nitrocellulose, and/or Nylon; resin such as santolite-type resins, such as Tosylamide Formaldehyde Resin; solvent such as Isopropyl Alcohol, Toluene, Butyl Acetate; and oil such as Mineral Oil. Typically, the composition is free of coloring agent and dries to a relatively colorless form.

The methyl vinyl ether maleic acid, such as Ethyl Ester of PVM/MA Copolymer, is typically added in amounts from about 14 to about 34% by volume (when supplied as a liquid), more typically about 22 to about 26% by volume, or about 24% by volume. The polymer may act as a binding agent when in use. Nitrocellulose is also typically added in amounts (when supplied as a liquid) from about 10 to about 20% by volume, more typically about 12 to about 16% by volume, or about 14% by volume. Nitrocellulose may act as a clarifying agent, also adding greater consistency and body to the composition as used. Nylon is typically added in amounts (when supplied as a solid) from about 0.5 to about 4% by weight, about 0.5 to about 1.5% by weight, or about 1% by weight. The Nylon is typically Nylon 6 and/or Nylon 66. Nylon may act as a seeding agent when the composition is in use. The polymers are typically laboratory grade or better.

The composition also contains a resin. A typical resin is of the santolite-type, such as Tosylamide Formaldehyde Resin (Benzenesulfonamide, 4-methyl-polymer with formaldehyde). Typically about 5 to about 15% by volume, and more typically from about 9 to about 13% by volume, or about 11% by volume of the resin is added. The resin may act as a polymer binding and/or strengthening agent when the composition is in use.

The mending composition further includes a solvent or mixture of solvents. A solvent can be used to solubilize the polymer(s) and/or resin. Lower boiling point solvents are typically used so that the composition dries quickly, once applied to hosiery. The solvents typically are aromatic hydrocarbons, lower alcohols and/or lower alkyl salts, such as alkyl acetates.

In certain embodiments, the solvents are Isopropyl Alcohol, Toluene and Butyl Acetate. Isopropyl Alcohol is used in amounts from about 1 to about 20% by volume, more typically from about 2% to about 4% by volume, or about 3% by volume. Toluene is typically added in amounts from about 13% to about 27% by volume, more typically about 18% to about 22% by volume, or about 20% by volume. Butyl Acetate is typically added in amounts from about 14% to about 38% by volume, about 24% to about 28% by volume, or about 26% by volume. The solvent is typically laboratory grade or better. The solvent is typically present in amounts sufficient to hold the methyl vinyl ether maleic acid and resin in solution such that the resulting flocculated composition is free flowing.

Toluene may be typically added for a purpose of dissolving a resin. Isopropyl may be typically for a purpose of dissolving a polymer. Butyl Acetate may be typically added for a purpose of dissolving a polymer and/or a resin.

The mending composition typically further includes an oil, such as Mineral Oil or other hydrocarbon-based oil. Mineral Oil is typically added in amounts from about 0.5 to about 4% by volume, about 0.5 to about 1.5% by volume, or about 1% by volume. The oil is typically phobic to at least one of the other portions of the composition; preferably the oil is phobic to all of the other portions of the composition. Further, preferably, the oil has no harmful, irritating, damaging, binding or other undesired interaction with skin, in particular human skin.

The mending composition may include a plasticizer or other agent or material for conditioning the composition, either as used or as mixed or as stored or otherwise.

A polymer may be included in an embodiment of the composition because it is characterized by an ability to bind with itself and with hosiery material. Hosiery material includes all known hosiery material in the art and materials with related properties. Examples include but are not limited to nylon and silk. A resin may be included in an embodiment of the composition because it is characterized by an ability to harden and enhance the binding strength. A resin may act in concert with a polymer, creating a film of binding material with different properties than either alone. A solvent may be included in an embodiment of the composition because it is characterized by an ability to hold a polymer and/or a resin in solution. An oil may be included in an embodiment of the composition because it is characterized by a phobic interaction with at least one other ingredient of the composition. An oil may be included in an embodiment of the composition because it is characterized by an ability to refrain from undesired interactions with skin, in particular human skin.

In operation, in one embodiment of the invention, a polymer or mix of polymers combined with a resin or mix of resins is in solution in a solvent or mix of solvents wherein the solution includes an oil or mix of oils in an emulsion. The embodiment is applied to hosiery material, whereupon the solvent or mix of solvents begin to leave the composition, preferably by evaporation. As the solvent(s) leave, the polymer(s) and resin(s) begin to solidify and bind among themselves and to the hosiery material. Also, the oil, being phobic to a significant portion of the remaining material, settles to an outside surface of the solidifying composition. The oil forms a protective barrier between the solidifying composition and other material, for example skin. There may be a variety of polymers and/or resins within the composition, wherein the variety of polymers and/or resins may act in concert to create a solidified mass, such as a film. The variety of polymers and/or resins may act as conditioning agents and/or seeding agents that may control or condition the final properties of the solidified mass.

In certain embodiments, the mending composition optionally can include an auxiliary ingredient(s), such as a coloring agent, fragrance or the like. In certain embodiments, a small amount of a coloring agent is included to match the color of the hosiery to which it is to be applied. The coloring agent is typically inert. For example, titanium dioxide can advantageously be included for white formulations. Certain pigments are known to settle out of formulations but can be redispersed with vigorous shaking. If such pigments are to be used, they can be dispersed in the formulation by any suitable means.

In certain embodiments, the composition is free of added Diakylphthalate (e.g., Dioctylphthalate, Dibutylphthalate). In additional embodiments, the composition is free of added Acetone. In other embodiments, the composition is free of added Methyl Ether Ketone (MEK) and/or Cyanoacrylate.

The composition is prepared by solubilizing the polymer(s) and resin in suitable solvent(s). The polymer/resin/solvent mixture(s), as appropriate, is/are mixed and other ingredients optionally are added and thoroughly mixed. Coloring agents and any optional auxiliary ingredients also can be added, although usually are not required.

The mending composition can be, for example, a liquid, gel or paste, and can be stored in any convenient form, such as for example, a container, a container with a brush, a roll-on container, any other type of container, or the like. Similarly, the composition can be applied in any convenient form, for example by brushing, spreading, roll-on, or the like. In a typical embodiment, the mending composition is in a container such as a tube and is dispensed as a gel. In certain embodiments, the mending composition is provided as a “one-shot applicator,” containing an amount sufficient for mending a single tear, hole or run. In other embodiments, the mending composition is provided in a multi-use container. The composition may be used to stop further damage to hosiery material and/or patch hosiery material.

The mending composition can be used to prevent or stop a tear, hole or run in hosiery. The composition is applied without a patch. When applied to a tear, hole or run in hosiery, the mending composition is malleable, quick drying, and adherent to the hosiery but generally not to the skin. The composition is applied by dispensing it on the tear, hole or run in hosiery. As needed, it can be spread over the tear, hole or run, such as with a brush or other small spreading implement. Such a spreading implement optionally can be part of the container.

The compositions of the invention are further described in the following examples. These examples are provided merely as illustrative of various aspects of the invention and shall not be construed to limit the invention in any way.

### EXAMPLES

### Example 1

A composition for mending hosiery is prepared. The composition comprises the following ingredients:
at least about 24% by volume Ethyl Ester of PVM/MA Copolymer
at least about 14% by volume Nitrocellulose
at least about 1% by weight Nylon 6
at least about 11% by volume Tosylamide Formaldehyde Resin
at least about 20% by volume Toluene
at least about 26% by volume n-Butyl Acetate
at least about 3% by volume Isopropyl Alcohol
at least about 1% by volume Mineral Oil

The composition may be prepared as follows: Ethyl Ester of PVM/MA Copolymer is solubilized in Isopropyl Alcohol. Nitrocellulose, Nylon and Tosylamide Formaldehyde Resin are solubilized in Butyl Acetate and Toluene. The components are mixed together and combined with Mineral Oil. The resulting mending composition is a gel-like liquid which dries to a relatively colorless form when applied to hosiery worn by a person.

### Example 2

A mending composition is prepared as follows:
1 part Sally Jansen “Hard As Nails” Nail Polish with Nylon
1 part Tresemme hair spray (European Tres Superhold)
1 part Johnson's Baby Oil

The composition is mixed and may be applied to hosiery.

### Example 3

A mending composition is prepared by combining Sally Jansen “Hard As Nails” Nail Polish with Nylon and Tresemme hair spray (European Tres Superhold) in a ratio of about 1:1 to about 3:1. A small amount of Baby Oil is also added.

### Example 4

The mending compositions described in Example 1, 2 or 3 was applied to a hole in pantyhose. The composition was allowed to dry; it formed a relatively clear solid. After drying, the pantyhose resisted further expansion of the hole, even after repeated stretching.

### Example 5

A composition for mending hosiery is prepared. The composition comprises the following ingredients:
at least about 24% by volume Ethyl Ester of PVM/MA Copolymer
at least about 14% by volume Nitrocellulose
at least about 1% by weight Nylon 6
at least about 11% by volume Tosylamide Formaldehyde Resin
at least about 2% by volume Toluene
at least about 1% by volume n-Butyl Acetate
at least about 8% by volume Isopropyl Alcohol
at least about 1% by volume Mineral Oil

It is understood that the above-described preferred embodiments are only illustrative of the application of the principles of the present invention. The present invention may be embodied in other specific forms without departing from its spirit or H essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the examples give specific examples, the scope of the composition is to be defined by the scope of the claims.

Additionally, although certain chemicals are listed as preferred, materials having substantially similar properties may be substituted as being within the scope of the claims.

It is also envisioned that the composition may be applied to any object made of hosiery material, not just material intended to be worn about the legs of a person.

More, it is envisioned that an ingredient may serve more than one function, for example wherein the ingredient may be a mixture of chemicals, or wherein the ingredient may change properties over time, or wherein the ingredient may otherwise have properties sufficient to serve more than one function.

Finally, it is envisioned that the ingredients may be kept separate, yet intended to be mixed before use.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A hosiery mending composition, comprising:
methyl vinyl ether maleic acid;
a resin; and
a solvent.

2. The hosiery mending composition of claim 1, further comprising a seed polymer characterized by an ability to initiate binding during solidification of the mending composition.

3. The hosiery mending composition of claim 1, further comprising an oil characterized by a phobic interaction with at least a substantial portion of the composition.

4. The hosiery mending composition of claim 1, wherein the resin comprises Tosylamide Formaldehyde Resin.

5. The hosiery mending composition of claim 3, further comprising nylon and nitrocellulose; and wherein the resin comprises Tosylamide Formaldehyde Resin.

6. The hosiery mending composition of claim 1, wherein the resin is characterized by an ability to harden and enhance binding strength of methyl vinyl ether maleic acid.

7. The hosiery mending composition of claim 1 wherein the solvent comprises a plurality of chemicals and wherein the solvent is characterized by an ability to hold methyl vinyl ether maleic acid and resin in solution and in an amount sufficient that the resulting composition is free flowing.

8. The hosiery mending composition of claim 1, further comprising:
about 14% to about 34% by volume of methyl vinyl ether maleic acid;
about 10% to about 20% by volume of Nitrocellulose;
about 0.5% to about 4% by weight of Nylon;
about 5% to about 15% by volume of a santolite-type resin;
about 1% to about 13% by volume of Isopropyl Alchohol;
about 13% to about 27% by volume of Toluene; and
about 14% to about 38% by volume of Butyl Acetate.

9. The hosiery mending composition of claim 8, further comprising about 0.5% to about 4% by volume of hydrocarbon-based oil.

10. The hosiery mending composition of claim 8, further comprising a coloring agent.

11. The hosiery mending composition of claim 2, wherein the seed polymer is nylon.

12. The hosiery mending composition of claim 8, wherein the santolite-type resin is Tosylamide Formaldehyde Resin.

13. A method of repairing a tear, hole, or run in hosiery, comprising the steps of:
applying to the tear, hole, or run an effective amount of a mending composition comprising:
methyl vinyl ether maleic acid;
a resin; and
a solvent; and
drying the mending composition.

14. The method of claim 13, wherein the mending composition further comprises a hydrocarbon-based oil.

15. The method of claim 13, wherein the mending composition further comprises:
about 14% to about 34% by volume of methyl vinyl ether maleic acid;
about 10% to about 20% by volume of Nitrocellulose;
about 0.5% to about 4% by weight of Nylon;
about 5% to about 15% by volume of a santolite-type resin;
about 1% to about 13% by volume of Isopropyl Alcohol;
about 13% to about 27% by volume of Toluene; and
about 14% to about 38% by volume of Butyl Acetate.

16. A hosiery mending composition comprising:
a binder that binds hosiery material;
a hardener that hardens the hosiery mending composition upon a solidification of the composition;
a solvent that holds the binder and the hardener in at least a flocculated solution; and
a lubricant for preventing the composition from adhering to human skin during and after solidification of the composition.

17. The hosiery mending composition of claim 16, wherein the binder comprises methyl vinyl ether maleic acid.

18. The hosiery mending composition of claim 17, wherein the lubricant is characterized by the absence of undesired interactions with human skin.

19. The hosiery mending composition of claim 17, wherein the solvent holds the binder and hardener in at least a free flowing flocculated solution.

20. The hosiery mending composition of claim 17, wherein the hardener is a resin.
